(19) United States
(12) Patent Application Publication
(10) Pub. No.: US 2018/0308243 A1
(43) Pub. Date: Oct. 25, 2018

(54) Cognitive Tracker -- Appliance For Enabling Camera-to-Camera Object Tracking in Multi-Camera Surveillance Systems

(71) Applicant: Irvine Sensors Corporation, Costa Mesa, CA (US)

(72) Inventor: James Justice, Huntington Beach, CA (US)

(73) Assignee: Irvine Sensors Corporation, Costa Mesa, CA (US)

(21) Appl. No.: 15/927,182

(22) Filed: Mar. 21, 2018

Related U.S. Application Data
(60) Provisional application No. 62/477,487, filed on Mar. 28, 2017.

(51) Int. Cl. G06T 7/292; H04N 5/247; G06K 9/46; G06K 9/32; G06T 7/246

(52) U.S. Cl. CPC G06T 7/292; H04N 5/247; G06K 9/4676; G06K 9/00973; G06T 7/248; G06T 2207/30232; G06K 9/3233

(57) ABSTRACT

A cognitive tracking system for objects of interest observed in multi-camera surveillance systems that are classified by their salient spatial, temporal, and color features. The features are used to enable tracking across an individual camera field of view, tracking across conditions of varying lighting or obscuration, and tracking across gaps in coverage in a multi-camera surveillance system. The invention is enabled by continuous correlation of salient feature sets combined with predictions of motion paths and identification of possible cameras within the multi-camera system that may next observe the moving objects.

### CROSS-REFERENCE TO RELATED APPLICATIONS

This application claims the benefit of U.S. Provisional Patent Application No. 62/477,487, filed on Mar. 28, 2017, entitled “Cognitive Tracking—An Appliance and Process Enabling Camera-to-Camera Object Tracking in Multi-camera Surveillance Systems Exploiting Cognitive-Inspired Techniques”, pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

### 1. Field of the Invention

The invention relates generally to the field of video analytics. More specifically, the invention relates to a video analytic processor that recognizes objects within multiple video image data streams and tracks the progress of salient objects, i.e., objects such as persons, vehicles, animals, etc., of interest to the surveillance system user, across different camera fields of view.

### 2. Description of the Related Art

Current video analytic systems process image data streams and primarily detect moving objects within those data streams. One particular level of object classification is achieved by correlating object size and object motion and selecting from predetermined classes of objects such as humans, vehicles, animals, etc., then assigning the detected object or objects to a user-defined, limited number of such categories. Tracking objects across multiple wide field of view surveillance camera video data streams in multi-camera systems is difficult to achieve, especially in environments with challenging viewing geometries or low lighting conditions and in areas between the multiple cameras where no camera coverage exists.

In some prior art systems, when objects are tracked within a single field of view, higher resolution cameras can be directed to track and recognize objects moving within the single surveillance camera field of view. Facial recognition is may be available if the tracking cameras have sufficient resolution and a favorable viewing angle. To date, no reliable solution to the problem of tracking salient objects, such as specific individuals, as they cross multiple fields of view from multiple cameras exists, including situations where gaps in camera coverage exist.

What is needed is a video analytic system that operates on multiple camera streams that continuously analyzes all the information content of the images of detected objects, stationary or moving, within the observed field. Spatial, temporal, and color characteristics of salient objects need to be continuously calculated for all camera streams and such features properly associated with the unique individual salient objects. Such a system needs to accomplish highly reliable tracking of salient objects using object signature content analysis combined with kinematic track estimation in order to operate through changes in viewing geometry, lighting conditions and across non-trivial gaps in camera coverage.

### BRIEF SUMMARY OF THE INVENTION

In the instant invention, highly reliable camera-to-camera tracking of objects moving within various camera fields of view in a multi-camera surveillance system is accomplished by:

1. Continuously calculating the defining characteristics of the objects of interest (i.e., salient) based on the objects' fine scale spatial, temporal, and color signatures which is enabled by instantiation of the invention on one or more Graphics Processing Units (GPUs) that are capable of executing the required massive parallel processing of multiple video data streams for real-time extraction of salient spatial, temporal, and color characteristics, thus creating a fine scale set of object features as signature correlations defining such objects (much like fingerprints define specific individuals), and,

2. Combining the above signature correlations with predictions of object motion path possibilities to permit reliable association across gaps in multi-camera sensor systems' fields of view. As salient objects of interest move from a first camera field of view to a second camera field of view to a third or more camera field of view, the assembly of salient features of the objects is used for high confidence association of the object with specific observations over multiple camera fields of view, even with appreciable gaps in camera viewing coverage

Salient object motion is analyzed in order to provide estimates of which camera's field of view the object is likely to enter, when the entry is likely to occur, and where within the camera field of view such tracked, salient object is likely to appear.

The combination of: a) salient signature correlations, b) motion prediction analyses, and, c) instantiation on uniquely architected processors enables the desired camera-to-camera tracking capabilities. The disclosed invention consists of an appliance and method in the form of a signal processing unit upon which is instantiated: 1) cognitive-inspired, multi-camera video data stream processing configured to achieve object classification and salient object selection, 2) frame-to-frame track association of detected and classified salient objects, and, 3) a kinematic analysis capability for motion prediction for possible paths of salient objects based upon observed object motion within a single camera field of view and determination of which subsequent camera fields of view the objects are predicted to enter if camera coverage gaps exist or occur. The output of the disclosed invention is salient object track maintenance across varying views of the salient object, varying lighting conditions affecting the observations, and across gaps in camera viewing coverage that may occur as the salient object traverses various cameras' fields of view.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 illustrates the process of emulation of neuroscience models for the human visual path image processing.

FIG. 2 illustrates the neuroscience-inspired video processing architecture of the invention that accomplishes the computations which emulate the human visual path image processing and exploitation by detecting and classifying salient objects within the video data streams and also accomplishes a look-to-look track association of salient objects within specific camera fields of view.

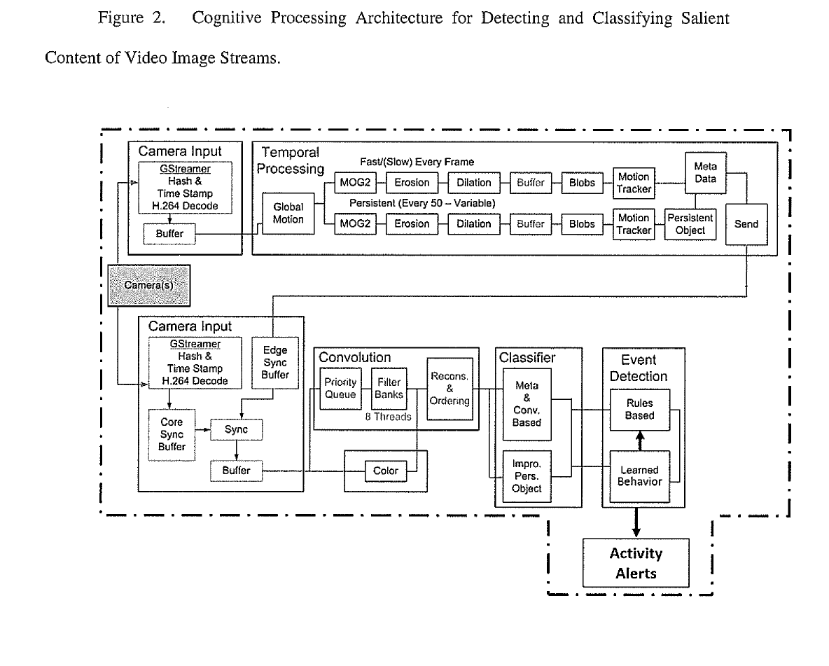

FIG. 3 illustrates the basic modeling approach taken to predict the likelihood of a salient, tracked object appearing in a subsequent camera field of view and the process for maintaining track association based on salient signature features and motion characteristics.

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

### DETAILED DESCRIPTION OF THE INVENTION

The instant invention models situation-processing in a way that emulates human situation awareness processing.

A first feature of the invention is the emulation in electronics of the human visual path saliency processing which examines massive flows of imagery data and determines areas and objects of potential interest based on object spatial, temporal, and color content. The electronics-based saliency processing determines degrees of correlation between sets of spatial, temporal, and color filters derived by processing small sections of contents of a video image. The processing preferably performs these functions over all the small segments of the video image in parallel. Temporal filtering is accomplished by looking at the small segments over a time series of the image segment that is observed and processed for consecutive frames.

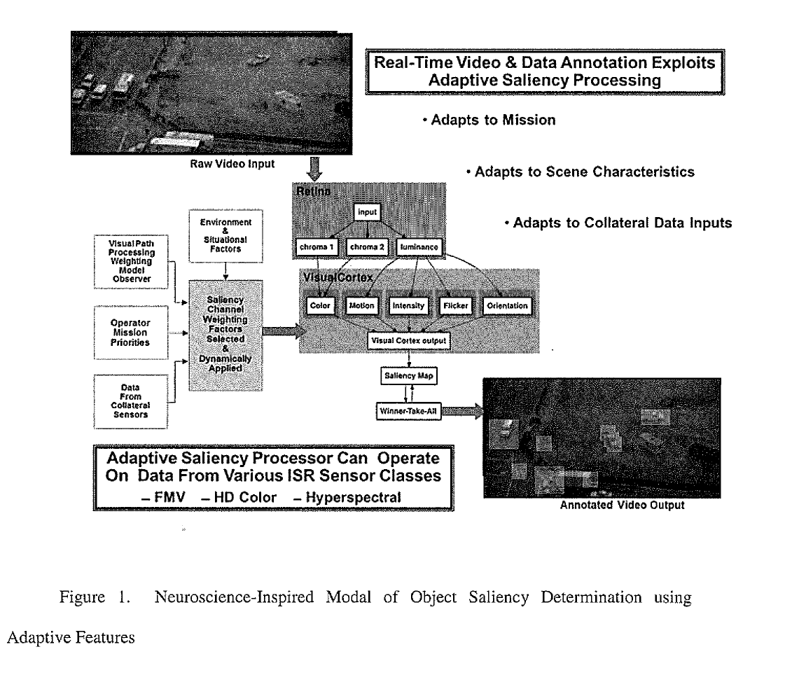

Extensions of neuroscience saliency models include adaption to observing conditions, operational concerns and priorities, and collateral data as illustrated in FIG. 1. Saliency-based detection and classification of targets and activities of interest in the areas around host platforms and the characterization of the data within the areas of interest initiates the saliency-based tracking process.

This approach enables a high degree of confidence in object tracking which uses the correlation of salient features over time to maintain object classification and recognition. This technique is capable of highly accurate assessment because it is based on the full information content from the imaging sensors and the full situational context of the platform about which the situation awareness is being developed.

An additional feature of the processing architecture is that the salient features of detected objects are calculated continuously across multiple frame sets in the video data streams. The calculations are preferably performed upon the detection of every object in every frame of data. Of particular importance is that the calculations be performed in near real-time on the object as it enters the field of view of any camera in the multi-camera system. In this manner, the salient characteristics are always available for every object being observed within the multiple camera fields of view.

A further feature of the invention takes advantage of the motion path and motion characteristics of detected salient objects in order to predict the objects' possible paths across unobserved scene sections that the objects being tracked by single cameras may traverse as they move thru the multi-camera fields of view.

Handoff between multiple cameras in a multi-camera system of the invention is accomplished based on expected kinematics of tracked objects and the correlation with the salient features that are the basis of object classification calculated for all tracked objects in all the cameras of the multi-camera clusters.

When a tracked object appears in an initial source camera, it is assigned a unique identifier lasting a pre-determined duration or period of time. A handoff registry is created when a tracked object traverses into a new camera field. Similarly, when an object is removed from a final destination camera system, all camera systems through which the object traversed are informed of the deletion. The source camera, which acts as home location for the tracked object, removes the entry from its home registry containing the generated unique ID of the tracked object and makes it available for allocation to a new object appearing in the camera system after all camera systems in the multi-camera cluster in the path of traversal have acknowledged removal of the entry from their respective hand-off registry. The individual camera systems may take their own actions on the metadata of the tracked object while removing from the home location or hand-off registry such as transferring the metadata for use with a timestamp of origination of the ID and timestamp of deletion of the ID from the registry in the home registry to avoid confusion between times of deletion from one camera system to another. Handoff between contiguous cameras is referred to herein as “quick hand-off” and, as between non-contiguous cameras as a “long hand-off”. Entry is made into an expected arrival table that is cleared after expiration of a predetermined period or life-time criteria or an input or message informing the system of the tracked object's arrival in another camera system.

In a preferred embodiment, each camera, exclusive of the periphery of the multi-camera system, maintains a neighbor list for each of eight (8) sectors including itself in each neighbor list. Each neighbor list may be comprised of all possible cameras to which a possible hand-off may occur. In case of a camera on the periphery, the neighbor list may include all possible multi-camera systems as well as cameras to which a hand-off may occur. While initiating a hand-off, the respective camera sends a message signaling object departure to all cameras in the matched neighbor list when a tracked object leaves its departure window.

The matched neighbor list is prepared based on the departure window falling within one or more of the eight sectors of the four sides of scene. If the departure window extends to more than one sector, then the matched neighbor list is prepared from the union of neighbor lists of sectors coincident with the departure window for hand-off initiation. Eight sectors of a scene constitute four corners extending to about one-third (⅓) on each of its adjacent sides and the remaining four segments from the four sides of the scene.

In case of overlap of scene coverage by contiguous cameras, a virtual boundary of the camera for preparing a neighbor list is assumed where the overlap of coverage intersects. While the tracked objects stay in overlap camera regions, the system continues to track same objects with same unique ID.

Quick hand-off is defined to occur between contiguous cameras in a multi-camera system when a tracked object leaves a camera through a departure window and arrives in another camera contiguous to it through an arrival window. Generally, arrival and departure windows will be the same physical regions of the scenes of all cameras in the matched neighbor list. In case the tracked object remains on the boundary or traverses along a boundary, a special exception handling of the tracked object is made.

In case of overlapped regions, a soft hand-off of the tracked object to other cameras occurs in the overlapped region based on a matched neighbor list. In the case of cameras which are in soft hand-off, each of the cameras individually tracks the object and coordinates with each other for tracking within area of soft hand-off. Where the object exits an overlapped area of one camera, it will make a quick hand-off according to the matched neighbor list at the segment departure window.

A long hand-off is initiated when a tracked object leaves a segment on the boundary of a camera located at the periphery of the multi-camera system where at least one neighbor in the matched neighbor list is included from outside the multi-camera system to which the current camera belongs. It is possible that an object may be in soft hand-off in other neighboring contiguous camera(s) while at the same time send out message of long hand-off by the current camera to all in the list. Likewise, in the case of the previously described case of soft hand-off, cameras may be configured to coordinate with other cameras in soft hand-off of the tracked object.

Each camera receiving a hand-off message keeps the following information for the tracked object in its look-out table:
1) Departure window of the tracked object;
2) Expected arrival window and segment of the object in camera;
3) Meta-data of the expected arriving object
4) Camera ID of the camera sending the hand-off message;
5) Keep-alive duration for the object in the table.

The hand-off message provides the above information except for the last keep-alive duration in the table. The keep-alive duration may be different in the cases of soft hand-off, quick hand-off or long hand-off provided in the hand-off message. If no newly detected object in the current camera is matched to the metadata, and possibly of the expected arrival window (in the case of quick and soft hand-off) of the entries in the table, the entry expires after a predetermined keep-alive duration and is removed as a result of expiration event.

The entry may also be removed earlier than the expiration even if a match is found in the look-out table for a newly detected object. On removal of the entry, the camera sends a response to the hand-off originating camera using the Camera ID from the removed entry. It then sends a successful or unsuccessful hand-off completion response message with the object ID in the entry.

The camera station initiating a hand-off makes an entry of hand-off request made with a reference count equal to the number of hand-off requests sent. It also keeps a predetermined expiration time for responses for the requests expected to be received. If all responses from camera stations are received before the expiration time, including the camera station to which hand-off successfully took place, the entry from the table is removed and the camera home location of the object is informed of successful hand-off including making an entry in its database of the hand-off along with associated metadata.

On expiration without a response of successful hand-off or if one or more of the stations do not respond, the entry is deleted from the table and the camera home location of the object is informed of the fact that the object has been lost from tracking.

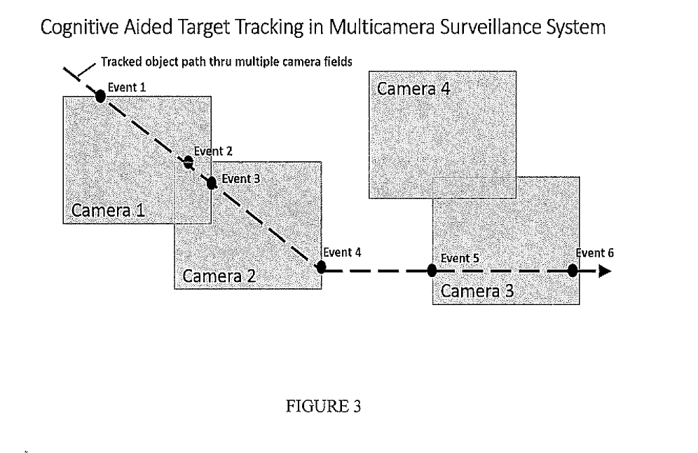

A preferred multi-camera tracking process is illustrated in FIG. 3.

In addition to the accuracy of the disclosed multiple camera tracking, timeliness of the related analysis is critical to maintain maximum possible kinematic correlation. Thus, a further feature of the invention is the instantiation of the software/firmware realizations of the invention on suitable processing elements, such as FPGAs and/or GPUs that provide massively parallel video data computation capabilities. Unique features of the software/firmware are preferably designed to exploit these parallel computation capabilities. By operating in this manner, video images can be divided into smaller segments and each co-processed for salient features in parallel. This accommodates large processing loads (many GigaOPS), thus enabling the tracking analyses to be accomplished with negligible (<1 sec) latency.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

What is claimed:

1. A track processing system comprising a special purpose, high thru put hardware processor with an instantiated family of image analysis and track processing functions that accomplishes tracking of objects of interest as they move from camera to camera in multi-camera surveillance systems under conditions of variable lighting and interrupted viewing.

2. Wherein the image analysis function of claim 1 accomplishes immediate calculation of fine scale salient features of objects of interest based on their spatial, temporal, and color content as they enter and traverse the field of view of a specific camera using techniques which emulate the human visual path processing of objects of interest.

3. Wherein the track processing function of claim 1 assigns a track identifier to objects of interest and maintains association of objects of interest with their fine scale salient feature sets as they move thru the field of view of the observing camera.

4. Wherein the image and track processing of claim 1 compares the salient feature sets of targets being observed within a cameras field of view when lighting or obscuration interrupts continuous viewing and reassigns the original associated track identifier with the original assigned object thru correlation of the salient feature sets of the object.

5. Wherein the track processing function of claim 1 calculates the path of motion of objects of interest across an individual camera field of view and, as the object leaves the camera's field of view, and predicts which cameras in the multi-camera surveillance system might next observe the moving object and enters the tracking identified and salient feature set data sent into a handoff registry.

6. Wherein the image analysis function of claim 1 immediately calculates the salient feature sets of the objects of interest as they enter new camera fields of view and compares the values of the feature set with the values of objects in the handoff registry and reassigns the tracking identifier to the objects with high feature set correlations to the object now being observed in a different camera field of view thus accomplishing tracking across gaps that may occur in the field of view of cameras on the multi-camera surveillance systems.

7. Wherein the track processing function of claim 1 deletes objects from the handoff registry when no new camera field of view is entered by the object for a selectable time interval.

8. Wherein the high thru put processor hardware of claim 1 which accomplishes the massively parallel image analysis processing that is required for accurate emulation of how the human visual path processes image data and accomplishes object classification may consist of arrays of Graphic Processing Units which may be integrated with additional processing capabilities of CPU and FPGA elements to accomplish the tracking functions.
